(19) United States
(12) Patent Application Publication
(10) Pub. No.: US 2014/0329464 A1
(43) Pub. Date: Nov. 6, 2014

(54) METHOD AND APPARATUS FOR PROVIDING MEDICAL IMAGES VIA NEAR-FIELD COMMUNICATION

(71) Applicant: Seung-Il Yoon, Hongcheon-gun (KR)

(72) Inventor: Seung-Il Yoon, Hongcheon-gun (KR)

(73) Assignee: SAMSUNG MEDISON CO., LTD., Gangwon-do (KR)

(21) Appl. No.: 14/358,629

(22) PCT Filed: Sep. 7, 2012
(86) PCT No.: PCT/KR2012/007219

§ 371 Date: May 15, 2014

(30) Foreign Application Priority Data
Nov. 16, 2011 (KR) 10-2011-0119788

(51) Int. Cl. H04B 5/00; G06F 19/00; H04W 4/00

(52) U.S. Cl. CPC H04B 5/0031; H04W 4/008; G06F 19/321
USPC 455/41.1

(57) ABSTRACT

A method of providing a medical image about a patient, performed by a medical image providing apparatus. The method includes receiving patient identification (ID) information from a patient terminal via near-field communication (NFC), searching for information about an object to be diagnosed, based on the patient ID information, and obtaining a medical image about the object, based on the searched for information.

### TECHNICAL FIELD One or more aspects of the present invention relate to a method and apparatus for providing a medical image via near-field communication (NFC).

### BACKGROUND ART

Recently, most medical institutes have established an internal private network, via which communication may be established between devices. However, in the case of WiFi, the same internal network, such as an access point, should be accessed to exchange data between devices. Thus, wireless network equipment should be installed within a medical institute. When an official internet protocol (IP) is used, both the devices should use an external server.

In the case of Bluetooth, a pairing process should be performed to connect devices. Here, ‘paring’ means a state that permits communication to be established between devices supporting Bluetooth. Also, when a plurality of devices supporting Bluetooth are located in the neighborhood, a user is inconvenienced since he/she should select devices to be connected.

Thus, there is a need to develop a system that enables a mobile device to be connected to a medical device in a simple manner and that enables medical data to be stably exchanged between the mobile device and the medical device.

### DISCLOSURE OF INVENTION

### Solution to Problem

The present invention provides a medical image providing method and apparatus capable of supporting near-field communication (NFC), and enabling exchange of a medical image between a medical device and a mobile device in a simple manner, via the NFC.

### Advantageous Effects of Invention

according to an embodiment of the present invention, the medical image providing apparatus may receive patient ID information from the patient terminal and obtain a medical image about a patient, based on the patient ID information, via the NFC. Accordingly, it is possible to reduce a time needed to examine the patient.

According to an embodiment of the present invention, the medical image providing apparatus may transmit the medical image to the patient terminal via the NFC, thereby reducing inconvenience caused when the medical image should be additionally stored in a CD or a DVD.

According to an embodiment of the present invention, a user may use the user terminal as an I/O device of the medical image providing apparatus by placing the user terminal within a predetermined distance from the medical image providing apparatus, e.g., on a holding station of the medical image providing apparatus. In this case, the size of the medical image providing apparatus may be reduced.

### BRIEF DESCRIPTION OF DRAWINGS

The above and other features and advantages of the present invention will become more apparent by describing in detail exemplary embodiments thereof with reference to the attached drawings in which:

FIG. 1 is a block diagram of a medical image providing system according to an embodiment of the present invention;

FIG. 2 is a block diagram of a medical image providing apparatus according to an embodiment of the present invention;

FIG. 3 is a block diagram of a user terminal according to an embodiment of the present invention;

FIG. 4 is a flowchart illustrating a method of providing a medical image to a patient terminal via near-field communication (NFC), according to an embodiment of the present invention;

FIG. 5 is a flowchart illustrating a method of exchanging data with a service engineer terminal via the NFC, performed by a medical image providing apparatus, according to an embodiment of the present invention;

FIG. 6 is a flowchart illustrating a method of receiving a control command from a user terminal, performed by a medical image providing apparatus, according to an embodiment of the present invention; and

FIG. 7 is a flowchart illustrating a method of checking information about permissions assigned to a user terminal, performed by a medical image providing apparatus, according to an embodiment of the present invention.

### BEST MODE FOR CARRYING OUT THE INVENTION

According to an aspect of the present invention, there is provided a medical image providing method of providing a medical image containing a result of examining a patient, performed by a medical image providing apparatus, the method including receiving patient identification (ID) information from a patient terminal via near-field communication (NFC); searching for information about an object to be diagnosed, based on the patient ID information; and obtaining a medical image about the object, based on the searched for information. The searching for the information about the object may include searching for the information about the object in a server, based on the patient ID information.

The method may further include transmitting the medical image to a server or the patient terminal.

The method may further include transmitting device information of the medical image providing apparatus to a service engineer terminal via the NFC; and receiving a result of performing a service related to the medical image providing apparatus from the service engineer terminal via the NFC. The device information may include at least one from among ID information and service history information of the medical image providing apparatus.

The method may further include transmitting ID information of the medical image providing apparatus to a user terminal, via the NFC; receiving a control command from the user terminal via the NFC; and performing the control command.

The method may further include transmitting the medical image to the user terminal via the NFC.

According to another aspect of the present invention, there is provided a method of providing a medical image, performed by a user terminal, the method including receiving identification (ID) information of a medical image providing apparatus from the medical image providing apparatus via near-field communication (NFC); displaying a set of virtual keys mapped to the ID information of the medical image providing apparatus; receiving a control command from the outside via the set of virtual keys; and transmitting the control command to the medical image providing apparatus via the NFC.

The method may further include receiving a medical image from the medical image providing apparatus via the NFC; and displaying the medical image.

The method may further include transmitting the medical image to a server.

According to another aspect of the present invention, there is provided an apparatus for providing medical images, the apparatus including a communication unit for receiving patient identification (ID) information from a patient terminal via near-field communication (NFC); a search unit for searching for information about an object to be diagnosed, based on the patient ID information; an image obtaining unit for obtaining a medical image about the object, based on the searched for information; and a controller for controlling the communication unit, the search unit, and the image obtaining unit.

According to another aspect of the present invention, there is provided a user terminal including a communication unit for receiving identification (ID) information of a medical image providing apparatus from the medical image providing apparatus and transmitting a control command received from the outside to the medical image providing apparatus, via near-field communication (NFC); a display unit for displaying a set of virtual keys mapped to the ID information of the medical image providing apparatus, and receiving the control command from the outside via the set of virtual keys; and a controller for controlling the communication unit and the display unit.

### MODE FOR THE INVENTION

This application claims the benefit of Korean Patent Application No. 10-2011-119788, filed on Nov. 16, 2011, in the Korean Intellectual Property Office, the disclosure of which is incorporated herein in its entirety by reference.

First, the terms used in the present disclosure will be briefly described below before exemplary embodiments of the present invention are described in greater detail.

Most of the terms used herein are general terms that have been widely used in the technical art to which the present invention pertains. However, some of the terms used herein may be created reflecting intentions of technicians in this art, precedents, or new technologies. Also, some of the terms used herein may be arbitrarily chosen by the present applicant. In this case, these terms are defined in detail below. Accordingly, the specific terms used herein should be understood based on the unique meanings thereof and the whole context of the present invention.

In the present specification, it should be understood that the terms, such as ‘including’ or ‘having,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Also, the terms, such as ‘unit’ or ‘module’, etc., should be understood as a unit that processes at least one function or operation and that may be embodied in a hardware manner, a software manner, or a combination of the hardware manner and the software manner.

Throughout the specification, the term ‘medical image’ means an image of an object, which is captured using ultrasound waves, an X-ray, high-frequency waves, or the like. Here, the ‘object’ may be understood to be part of a human body. For example, the object may be an organ of a human body, such as the liver, the heart, the womb, a brain, the breast, or the abdomen, or a fetus.

If the medical image is an ultrasound image, the ultrasound image may be embodied in any of various forms. For example, the ultrasound image may include at least one selected from the group consisting of a brightness (B) mode image, a color (C) mode image, and a Doppler (D) mode image. According to an embodiment of the present invention, the ultrasound image may be a two-dimensional (2D) or three-dimensional (3D) image.

Throughout the specification, the term ‘user’ may be a medical professional, e.g., a doctor, a nurse, a clinical pathologist, or a medical imaging professional, but is not limited thereto.

As used herein, expressions such as “at least one of,” when preceding a list of elements, modify the entire list of elements and do not modify the individual elements of the list.

The present invention will now be described more fully with reference to the accompanying drawings, in which exemplary embodiments of the invention are shown. This invention may, however, be embodied in many different forms and should not be construed as being limited to the embodiments set forth herein. Rather, these embodiments are provided so that this disclosure will be thorough and complete and will fully convey the concept of the invention to those of ordinary skill in the art. For clarity, in the drawings, constitutional elements that are not related to embodiments of the present invention are not illustrated. The same reference numerals represent the same elements throughout the drawings.

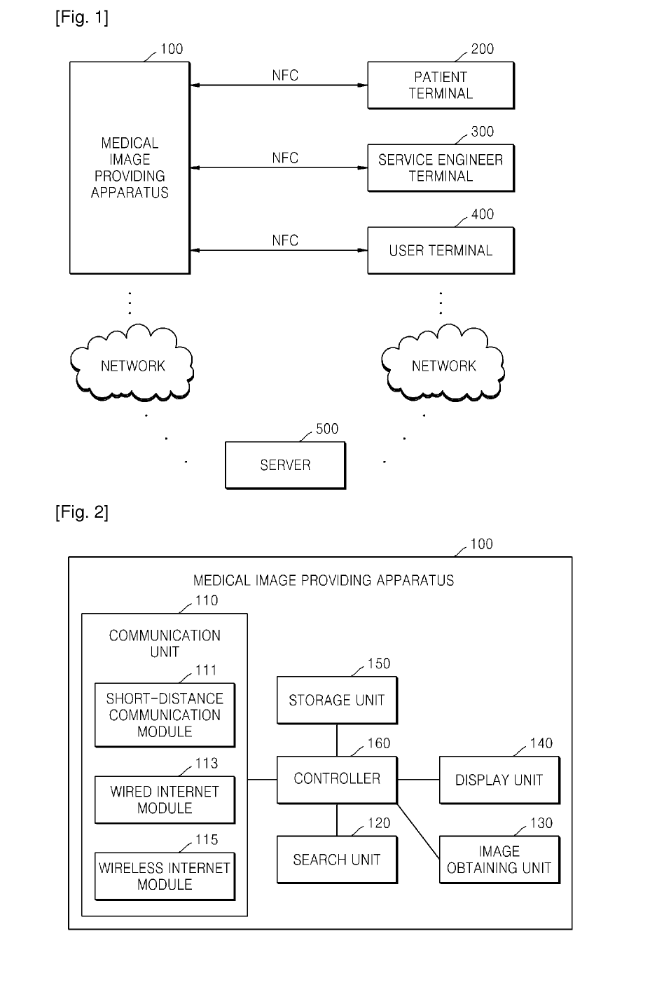

FIG. 1 is a block diagram of a medical image providing system according to an embodiment of the present invention. Referring to FIG. 1, the medical image providing system may include a medical image providing apparatus 100, a patient terminal 200, a service engineer terminal 300, and a user terminal 400.

The medical image providing apparatus 100 means an apparatus capable of capturing a medical image about an object for medical treatment and displaying the medical image. Examples of the medical image providing apparatus 100 may include, but are not limited to, a magnetic resonance imaging (MRI) device, ultrasound diagnostic equipment, a computed tomography (CT) device, an X-ray diagnosis device, and the like.

The medical image providing apparatus 100 may include a near-field communication (NFC) chip for establishing NFC. The NFC is a technology whereby data is exchanged between devices within a short distance of about 10 cm by using radio-frequency identification (RFID), e.g., a non-contact type short-distance wireless communication module that uses a frequency band of 13.56 Mz.

According to an embodiment of the present invention, the NFC chip may be installed inside the medical image providing apparatus 100 or may be installed outside the medical image providing apparatus 100 in the form of dongle. Also, according to another embodiment of the present invention, the NFC chip may be installed into a holding stage or a control panel of the medical image providing apparatus 100.

Since the NFC supports both a read operation and a write operation, the medical image providing apparatus 100 may write device information thereof in an NFC tag and may read data from an external device via the NFC.

The medical image providing apparatus 100 may communicate with a server 500 in a wired/wireless manner. The structure of the medical image providing apparatus 100 will be described with reference to FIG. 2 below.

The patient terminal 200 means a mobile terminal of a patient to be examined, and may be embodied in any of various forms. For example, the patient terminal 200 may be a mobile phone, a smart phone, a personal digital assistant (PDA), a portable multimedia player (PMP), a navigation device, an e-book terminal, a tablet personal computer (PC), or the like.

The patient terminal 200 may store patient identification (ID) information of the patient. For example, the patient ID information may be stored in an NFC tag stored in the patient terminal 200.

Thus, according to an embodiment of the present invention, the patient terminal 200 may be used instead of a medical card of the patient, thereby reducing inconvenience caused when the patient should carry his/her additional medical card with him/her.

The service engineer terminal 300 means a terminal of a service engineer who provides services, e.g., providing the medical image providing apparatus 100, repairing the medical image providing apparatus 100, and updating software (SW) installed in the medical image providing apparatus 100.

The service engineer terminal 300 according to an embodiment of the present invention may be embodied in any of various forms. For example, the service engineer terminal 300 may be a mobile phone, a smart phone, a PDA, a PMP, a navigation device, an e-book terminal, a table PC, or the like.

The service engineer terminal 300 may establish the NFC with the medical image providing apparatus 100. In other words, an NFC chip may be installed in the service engineer terminal 300.

The service engineer terminal 300 may establish wireless communication with a servicer server (not shown). That is, the service engineer terminal 300 may transmit a result of performing a service to the service server via wireless communication.

The user terminal 400 means a terminal of a medical professional, e.g., a doctor, a nurse, a clinical pathologist, or a medical imaging professional. A user may use the user terminal 400 to input a control command or to check a medical image captured by the medical image providing apparatus 100. That is, the user may use the user terminal 400 as an input/output (I/O) device of the medical image providing apparatus 100.

The user terminal 400 according to an embodiment of the present invention may be embodied in any of various forms. For example, the user terminal 400 may be a mobile phone, a smart phone, a PDA, a PMP, a navigation device, an e-book terminal, a table PC, or the like.

The user terminal 400 may exchange data with the medical image providing apparatus 100 via the NFC. Also, the user terminal 400 may establish wireless communication with the server 500. Thus, the user terminal 400 may provide data received from the medical image providing apparatus 100 to the server 500.

The server 500 is a server, e.g., a server of a medical institute, for providing a medical service.

Information about the patient, which includes the patient ID information, information about medical images captured by the medical image providing apparatus 100, and examination requirements input by a medical professional, may be stored in the server 500. The examination requirements may include information about an object to be diagnosed.

According to an embodiment of the present invention, the server 500 may be connected to at least one from among the medical image providing apparatus 100 and the user terminal 400, via a network. Thus, the server 500 may exchange data with the medical image providing apparatus 100 or the user terminal 400.

For example, the server 500 may receive a request for the information about the object, which includes the patient ID information, from the medical image providing apparatus 100. In this case, the server 500 may check the examination requirements mapped to the patient ID information, and extract the information about the object from the examination requirements. Then, the server 500 may transmit the extracted information to the medical image providing apparatus 100.

The structure of the medical image providing apparatus 100 will now be described in detail with reference to FIG. 2.

FIG. 2 is a block diagram of a medical image providing apparatus 100 according to an embodiment of the present invention. Referring to FIG. 2, the medical image providing apparatus 100 may include, but is not limited to, a communication unit 110, a search unit 120, an image obtaining unit 130, a display unit 140, a storage unit 150, and a controller 160. In other words, the medical image providing apparatus 100 may further include other elements or may include only some of the elements illustrated in FIG. 2.

The communication unit 110 may include at least one module that allows the medical image providing apparatus 100 to communicate with the patient terminal 200, the service engineer terminal 300, the user terminal 400, and the server 500.

For example, the communication unit 110 may include a short-distance communication module 111, a wired internet module 113, a wireless internet module 115, and the like.

The short-distance communication module 111 is a module for short-distance communication. Examples of short-distance communication technology include Bluetooth, RFID, Infrared Data Association (IrDA), Ultra WideBand (UWB), ZigBee, the NFC, and the like. In the present specification, the NFC is employed as an example of short-distance communication technology.

The communication unit 110 may receive patient ID information from the patient terminal 200 via the NFC. Also, the communication unit 110 may transmit a captured medical image to the patient terminal 200 or the user terminal 400 via the NFC.

The communication unit 110 may transmit device information of the medical image providing apparatus 100 to the service engineer terminal 300 and receive a result of performing a service related to the medical image providing apparatus 100 from the service engineer terminal 300, via the NFC.

The communication unit 110 may transmit ID information of the medical image providing apparatus 100 to the user terminal 400, via the NFC. In this case, according to an embodiment of the present invention, the communication unit 110 may receive ID information of the user terminal 400 via the NFC to check information about permissions assigned to the user terminal 400.

According to an embodiment of the present invention, if the permissions assigned to the user terminal 400 are verified, the communication unit 110 may receive a control command from the user terminal 400 via the NFC.

The wired internet module 113 is a module for accessing the Internet in a wired manner. The wireless internet module 115 is a module for accessing the Internet in a wireless manner, and may be installed inside or outside the medical image providing apparatus 100.

According to an embodiment of the present invention, the communication unit 110 may transmit a captured medical image to the server 500 by using the wired internet module 113 or the wireless internet module 115.

The search unit 120 may search for information about an object to be diagnosed, based on the patient ID information. According to an embodiment of the present invention, the patient ID information may include information that identifies a patient, e.g., an identifier (ID), birth date, resident registration number, and passport number of the patient.

According to an embodiment of the present invention, if examination requirements about the patient are stored in the medical image providing apparatus 100, the search unit 120 may search the examination requirements for information about an object to be diagnosed.

The examination requirements mean information about items to be examined, and may specify the type of examination, e.g., magnetic resonance imaging (MRI), a ultrasound diagnosis, computed tomography (CT) scanning; information about an object to be diagnosed, e.g., the liver, the breast, the womb, a fetus, the brain, or blood vessels; a medical department, e.g., the department of obstetrics, the department of gynecology, the department of pediatrics, the department of chest surgery, the department of radiology, and the department of neurosurgery; information about a medical attendant, e.g., the ID and name of the medical attendant; additional examination conditions, and the like.

According to another embodiment of the present invention, if the examination requirements are stored in the server 500, the search unit 120 may search the server 500 for information about an object to be diagnosed, based on the patient ID information.

In other words, the search unit 120 may automatically search the server 500 for a work list mapped to the patient ID information to obtain the examination requirements, and extract information about an object to be diagnosed from the examination requirements.

The image obtaining unit 130 may obtain a medical image regarding the subject, based on the extracted information. According to an embodiment of the present invention, the medical image may be an ultrasound image, an MRI image, a CT image, or the like.

According to an embodiment of the present invention, the medical image may include a plurality of images. In this case, the image obtaining unit 130 may obtain the plurality of images at predetermined time intervals.

The display unit 140 may display the medical image. The display unit 140 may further display information about the patient, a medical history, and previously stored medical images that are mapped to the patient ID information.

According to an embodiment of the present invention, the display unit 140 may display a result of searching based on the patient ID information. For example, the display unit 140 may display examination requirements mapped to the patient ID information. In this case, a user may rapidly obtain the medical image regarding the object by checking the displayed examination requirements.

The storage unit 150 may store medical images. In this case, the storage unit 150 may classify and store the medical images according to a patient and an examination date.

According to an embodiment of the present invention, the storage unit 150 may store information about the patient, which includes the patient ID information. The storage unit 150 may further store the examination requirements mapped to the patient ID information.

According to an embodiment of the present invention, the storage unit 150 may store information about the user terminal 400. According to an embodiment of the present invention, the information about the user terminal 400 may include ID information of the user terminal 400, information about permissions assigned to the user terminal 400, and the like. The information about the permissions means information about permissions assigned to the user terminal 400 to control the medical image providing apparatus 100 via the NFC.

In other words, the user terminal 400 that is assigned permissions, the information of which has been stored in the storage unit 150, may be used as an I/O unit of the medical image providing apparatus 100 via the NFC.

According to an embodiment of the present invention, the storage unit 150 may be installed inside the medical image providing apparatus 100 or may be an external memory device.

The controller 160 may perform a control command received from the user terminal 400. That is, a user may provide a control command to the medical image providing apparatus 100 via the user terminal 400.

The controller 160 may check the information about the permissions assigned to the user terminal 400, based on the ID information of the user terminal 400. In other words, the controller 160 may determine whether the user terminal 400 located within a predetermined distance from the medical image providing apparatus 100 is assigned permission to control the medical image providing apparatus 100.

The controller 160 may control overall operations of the communication unit 110, the search unit 120, the image obtaining unit 130, the display unit 140, and the storage unit 150.

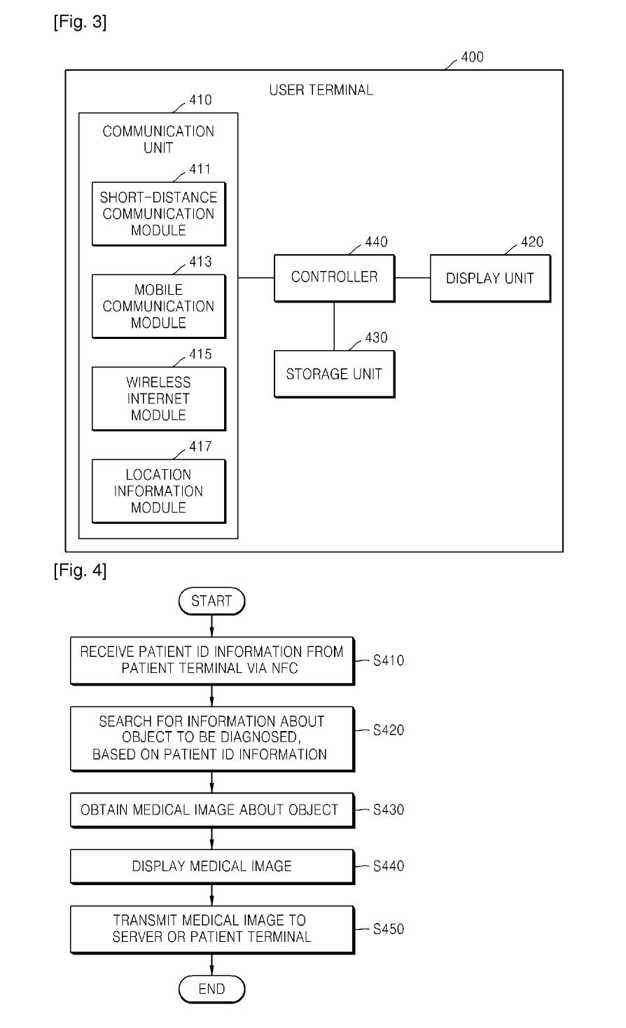

FIG. 3 is a block diagram of a user terminal 400 according to an embodiment of the present invention. Referring to FIG. 3, the user terminal 400 may include, but is not limited to, a communication unit 410, a display unit 420, a storage unit 430, and a controller 440. In other words, the user terminal 400 may further include other elements or may include only some of these elements.

The communication unit 410 may include at least one device that allows the user terminal 400 to communicate with the medical image providing apparatus 100 or the server 500 of FIG. 1. For example, the communication unit 410 may include a short-distance communication module 411, a mobile communication module 413, a wireless internet module 415, and a location information module 417.

The short-distance communication module 411 is a module for establishing short-distance communication. Examples of short-distance communication technology include Bluetooth, RFID, IrDA, UWB, ZigBee, the NFC, and the like. In the present specification, the NFC is employed as an example of short-distance communication technology.

The mobile communication module 413 exchanges a radio signal with at least one from among a base station, an external terminal, and a server present in a mobile communication network. The radio signal may include any of various types of data for exchanging a medical image.

The wireless internet module 415 is used to access the Internet in a wireless manner, and may be installed inside or outside the user terminal 400.

The location information module 417 is used to detect the location of or obtain location information about the user terminal 400. For example, the location information module 417 may be a global positioning system (GPS) module. The GPS module receives location information from a plurality of artificial satellite. Here, the location information may include coordinates information indicated by a latitude and a longitude.

According to an embodiment of the present invention, the communication unit 410 may receive ID information of the medical image providing apparatus 100 from the medical image providing apparatus 100 via the NFC. Also, the communication unit 410 may transmit a control command received from the outside to the medical image providing apparatus 100, via the NFC.

According to an embodiment of the present invention, the communication unit 410 may receive a medical image from the medical image providing apparatus 100 and transmit the medical image to the server 500, via the NFC. Thus, even if the medical image providing apparatus 100 is not accessible to a network, the medical image providing apparatus 100 may transmit the medical image to the server 500 via the user terminal 400.

The display unit 420 displays information processed by the user terminal 400. For example, the display unit 420 may display a medical image received from the medical image providing apparatus 100. Also, the display unit 420 may display a set of virtual keys mapped to the information of the medical image providing apparatus 100.

If the display unit 420 and a touch pad form a touch screen together in an inter-layered structure, then the display unit 420 may be used not only as an output device but also as an input device. The display unit 420 may include at least one from among a liquid crystal display (LCD), a thin-film transistor (TFT)-LCD, an organic light-emitting diode, a flexible display, and a three-dimensional (3D) display. At least two display units 420 may be included in the user terminal 400 according to the structure of the user terminal 400.

The touch screen may be constructed to sense a location thereof that is touched, the size of the touched location, and a pressure applied to the location when touched. Also, the touch screen may be constructed to sense not only real touching but also proximity touching.

When the display unit 420 displays the set of virtual keys, the display unit 420 may receive a control command from the outside. In other words, a user may input the control command on the touch screen by using the set of virtual keys displayed on the user terminal 400.

The storage unit 430 may store the ID information and user information, e.g., user

ID, of the user terminal 400, the medical image regarding the patient, information about a result of examining the patient, and the like.

According to an embodiment of the present invention, the storage unit 430 may store the ID information of the user terminal 400, user ID, and authentication code, in an NFC tag.

The storage unit 430 may store a set of virtual key sets mapped to the ID information of the user terminal 400. According to an embodiment of the present invention, the set of virtual keys means a set of input keys needed to express a specific language or to control a particular mode or menu of the medical image providing apparatus 100.

The controller 440 may control overall operations of the communication unit 410, the display unit 420, and the storage unit 430.

FIG. 4 is a flowchart illustrating a method of providing a medical image to a patient terminal via the NFC, according to an embodiment of the present invention. Referring to FIGS. 1 and 4, the medical image providing apparatus 100 may receive patient ID information from the patient terminal 200 via the NFC (operation S410).

According to an embodiment of the present invention, when the patient terminal 200 is located within a predetermined distance, e.g., a radius of 8 cm, from the medical image providing apparatus 100, the medical image providing apparatus 100 may read an NFC tag stored in the patient terminal 200 to obtain the patient ID information.

For example, if ‘12345’ is written as a patient ID of a patient A to the NFC tag in the patient terminal 200, the medical image providing apparatus 100 receives ‘patient ID: 12345’ as the patient ID information from the patient terminal 200.

Thus, according to an embodiment of the present invention, the patient A does not need to carry his/her medical card with him/her, and may use his/her patient terminal 200 in place of the medical card.

Then, the medical image providing apparatus 100 may search for information about an object to be diagnosed, based on the patient ID information (operation S420).

According to an embodiment of the present invention, if medical records and examination requirements about the patient A are stored in the medical image providing apparatus 100, then the information about the object may be searched for in the medical image providing apparatus 100.

According to another embodiment of the present invention, if examination requirements or medical records about the patient A that were recorded by a medical professional are stored in the server 500, then the medical image providing apparatus 100 may search the server 500 for the information about the object server 500, based on the patient ID information.

In this case, according to an embodiment of the present invention, the medical image providing apparatus 100 may obtain the information about the object by searching for a work list mapped to the patient ID information.

For example, if the patient A has liver cancer, a medical image about the liver of the patient A may be needed to determine whether the liver cancer is a benign or malignant tumor. In this case, the medical image providing apparatus 100 may obtain information about the liver of the patient A to be diagnosed by receiving the ‘patient ID: 12345’ as the patient ID information of the patient A from the patient terminal 200 and searching for examination requirements or medical records mapped to the ‘patient ID: 12345’.

Thus, according to an embodiment of the present invention, a user may receive the patent ID information from the patient terminal 200 without having to additionally input information about the patient A and extract information about an object to be diagnosed, based on the patient ID information. Accordingly, it is possible to rapidly examine the patient A.

Then, the medical image providing apparatus 100 may obtain a medical image about the object (operation S430). According to an embodiment of the present invention, the medical image may be an MRI image, an ultrasound image, or a CT image. Accordingly, a user should check examination requirements mapped to the patient ID information.

According to an embodiment of the present invention, a user may define the type of a medical image and an object by checking the examination requirements. In this case, the medical image providing apparatus 100 may obtain a medical image about the defined object.

Then, the medical image providing apparatus 100 may display the medical image (operation S440). A user may make a diagnosis in regard to the case of the patient A by checking the displayed medical image.

According to an embodiment of the present invention, the medical image providing apparatus 100 may store a medical image. In this case, the medical image providing apparatus 100 may display an obtained medical image or may not display the medical image.

Thereafter, the medical image providing apparatus 100 may transmit the medical image to the server 500 or the patient terminal 200 (operation S450).

According to an embodiment of the present invention, since the medical image providing apparatus 100 transmits a medical image to the server 500 via a wired/wireless communication, the medical image may be stably stored. Furthermore, the medical image providing apparatus 100 may easily share a medical image with other devices connected thereto via a network by using the server 500.

According to another embodiment of the present invention, the medical image providing apparatus 100 may transmit a medical image to the patient terminal 200 via the NFC. In other words, according to another embodiment of the present invention, a user does not need to additionally store a medical image about a patient in a universal serial bus (USB) memory, a compact disc (CD), or a digital versatile disc (DVD), and the patient may store the medical image in the patient terminal 200, thereby increasing user convenience.

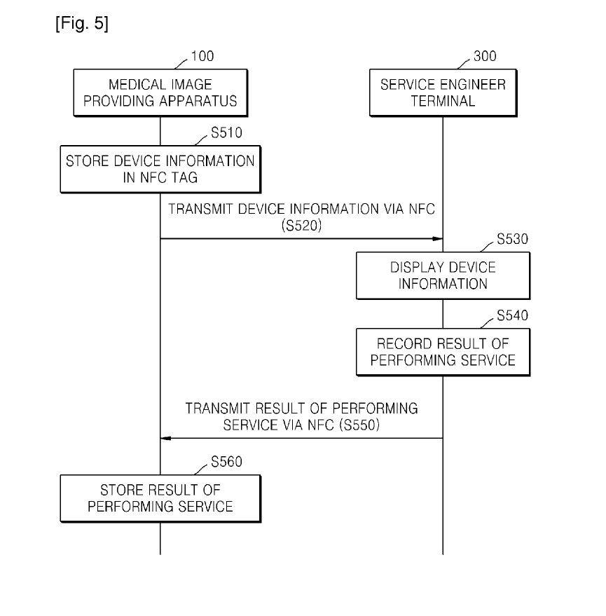

FIG. 5 is a flowchart illustrating a method of exchanging data with a service engineer terminal via the NFC, performed by a medical image providing apparatus, according to an embodiment of the present invention. Referring to FIGS. 1 and 5, the medical image providing apparatus 100 may store device information thereof in an NFC tag (operation S510). According to an embodiment of the present invention, the device information may include at least one from among ID information of the medical image providing apparatus 100, e.g., hardware specifications and software version, and service history information.

According to an embodiment of the present invention, the service history information may include information about, for example, services of repairing, exchanging machine parts in, and upgrading software in the medical image providing apparatus 100, and information about a service engineer who provides such a service.

According to an embodiment of the present invention, the medical image providing apparatus 100 may transmit the device information thereof to the service engineer terminal 300, via the NFC (operation S520). In this case, according to an embodiment of the present invention, the service engineer terminal 300 may display the device information about the medical image providing apparatus 100 (operation S530). Thus, a service engineer may easily check the device information of the medical image providing apparatus 100.

According to an embodiment of the present invention, the service engineer may record a result of performing a service related to the medical image providing apparatus 100, via the service engineer terminal 300 (operation S540). In this case, the service engineer terminal 300 may transmit the result of the performing to a service server (not shown), or may transmit the result of the performing to the medical image providing apparatus 100 via the NFC (operation S550). The result of the performing may mean a result of repairing, upgrading software in, or exchanging hardware in the medical image providing apparatus 100 by the service engineer.

According to an embodiment of the present invention, the medical image providing apparatus 100 stores the result of the performing received from the service engineer terminal 300 (operation S560). In this case, the medical image providing apparatus 100 may add the result of the performing to the service history information recorded in an NFC tag.

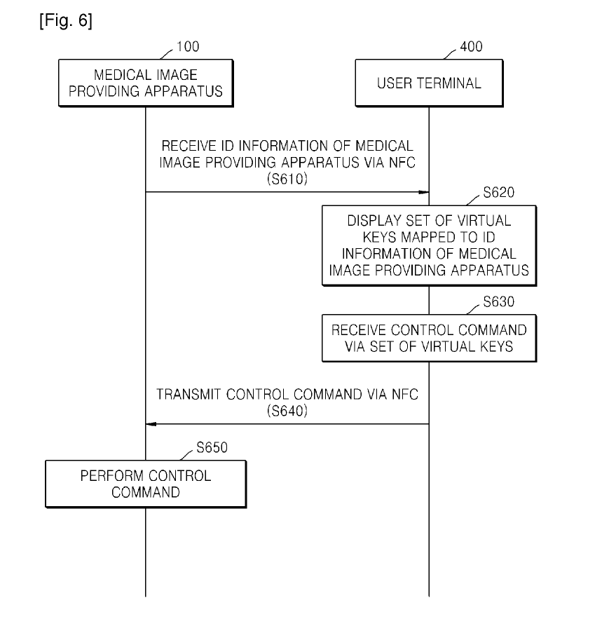

FIG. 6 is a flowchart illustrating a method of receiving a control command from a user terminal, performed by a medical image providing apparatus, according to an embodiment of the present invention. Referring to FIGS. 1 and 6, the user terminal 400 may receive ID information of the medical image providing apparatus 100 via the NFC (operation S610). The ID information of the medical image providing apparatus 100 may include, for example, serial numbers, model information, and ID of the medical image providing apparatus 100. If the user terminal 400 is located within a predetermined distance, e.g., within a radius of 10 cm, from the medical image providing apparatus 100, then the medical image providing apparatus 100 may transmit the ID information thereof to the user terminal 400 via the NFC.

According to an embodiment of the present invention, the user terminal 400 may display a set of virtual keys mapped to the ID information of the medical image providing apparatus 100 (operation S620). For example, the user terminal 400 may display a set of virtual keys A when the medical image providing apparatus 100 is an ‘A’ model, and display a set of virtual keys B when the medical image providing apparatus 100 is a ‘B’ model.

Then, the user terminal 400 may receive a control command by using the set of virtual keys (operation S630). In other words, a user may input the control command by using the set of virtual keys displayed on the user terminal 400. For example, the user may select an image mode or input a command by using the set of virtual keys.

According to an embodiment of the present invention, the user terminal 400 may display a set of virtual keys for an operating menu or mode of the medical image providing apparatus 100.

Thus, according to an embodiment of the present invention, the user terminal 400 may be used as an I/O device of the medical image providing apparatus 100, thereby reducing the size of the medical image providing apparatus 100.

According to an embodiment of the present invention, the user terminal 400 may transmit the control command to the medical image providing apparatus 100 via the NFC (operation S640). Then, the medical image providing apparatus 100 may receive and perform the control command (operation S650).

In the case of the NFC, a pairing process does not need to be performed between devices, data stored in an NFC tag in a device can be read even when the device is not powered on, and communication may be established between only a pair of devices. Thus, even if the user terminal 400 is used as an I/O device of the medical image providing apparatus 100 via the NFC, it is possible to guarantee security for information about a patient or a result of examining the patient.

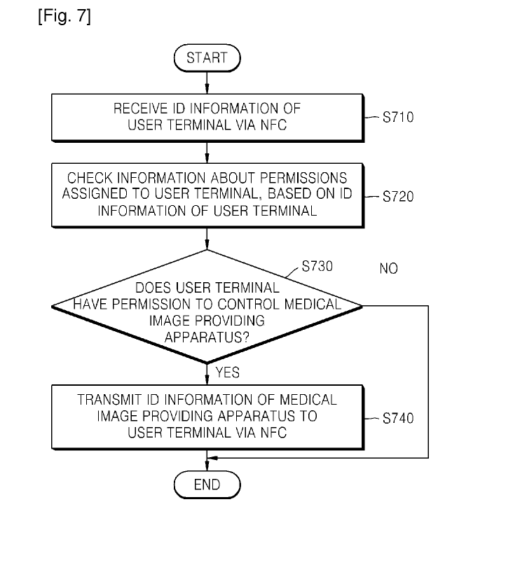

FIG. 7 is a flowchart illustrating a method of checking information about permissions assigned to a user terminal, performed by a medical image providing apparatus, according to an embodiment of the present invention.

Referring to FIGS. 1 and 7, according to an embodiment of the present invention, the medical image providing apparatus 100 may receive ID information of the user terminal 400 via the NFC (operation S710). The ID information of the user terminal 400 may include the ID, mobile telephone number, user ID, and personal ID number (PIN) of the user terminal 400.

According to an embodiment of the present invention, the medical image providing apparatus 100 may check information about permissions assigned to the user terminal 400, based on the ID information of the user terminal 400 (operation S720).

For example, it is assumed that the ID information of the user terminal 400 capable of controlling the medical image providing apparatus 100 has been registered with a database of the medical image providing apparatus 100. Then, the medical image providing apparatus 100 may compare the ID information of the user terminal 400 with the registered ID information of the user terminal 400. Then, the medical image providing apparatus 100 may determine whether the user terminal 400 has permission to control the medical image providing apparatus 100 (operation S730).

If it is determined in operation S730 that the user terminal 400 does not have the permission, then the medical image providing apparatus 100 may not provide the user terminal 400 with ID information of the medical image providing apparatus 100. In this case, a user cannot use the user terminal 400 as an I/O device of the medical image providing apparatus 100.

If it is determined in operation S730 that the user terminal 400 has the permission, then the medical image providing apparatus 100 transmits the ID information thereof to the user terminal 400 via the NFC (operation S740). In this case, the user terminal 400 may display a set of virtual keys for controlling the medical image providing apparatus 100, based on the ID information of the medical image providing apparatus 100.

Thus, according to an embodiment of the present invention, only when it is verified that the user terminal 400 has permission to control the medical image providing apparatus 100, a user can use the user terminal 400 as an I/O device of the medical image providing apparatus 100.

According to another embodiment of the present invention, the medical image providing apparatus 100 may request the user terminal 400 to provide additional authentication information so as to determine whether the user terminal 400 has permission to use the medical image providing apparatus 100.

The above embodiments of the present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on.

As described above, according to an embodiment of the present invention, the medical image providing apparatus 100 may receive patient ID information from the patient terminal 200 and obtain a medical image about a patient, based on the patient ID information, via the NFC. Accordingly, it is possible to reduce a time needed to examine the patient.

According to an embodiment of the present invention, the medical image providing apparatus 100 may transmit the medical image to the patient terminal 200 via the NFC, thereby reducing inconvenience caused when the medical image should be additionally stored in a CD or a DVD.

According to an embodiment of the present invention, a user may use the user terminal 400 as an I/O device of the medical image providing apparatus 100 by placing the user terminal 400 within a predetermined distance from the medical image providing apparatus 100, e.g., on a holding station of the medical image providing apparatus 100. In this case, the size of the medical image providing apparatus 100 may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A medical image providing method of providing a medical image containing a result of examining a patient, performed by a medical image providing apparatus, the method comprising:
receiving patient identification (ID) information from a patient terminal via near-field communication (NFC);
searching for information about an object to be diagnosed, based on the patient ID information; and
obtaining a medical image about the object, based on the searched for information.

2. The method of claim 1, wherein the searching for the information about the object comprises searching for the information about the object in a server, based on the patient ID information.

3. The method of claim 1, further comprising transmitting the medical image to a server or the patient terminal.

4. The method of claim 1, further comprising:
transmitting device information of the medical image providing apparatus to a service engineer terminal via the NFC; and
receiving a result of performing a service related to the medical image providing apparatus from the service engineer terminal via the NFC.

5. The method of claim 4, wherein the device information comprises at least one from among ID information and service history information of the medical image providing apparatus.

6. The method of claim 1, further comprising:
transmitting ID information of the medical image providing apparatus to a user terminal, via the NFC;
receiving a control command from the user terminal via the NFC; and
performing the control command.

7. The method of claim 6, wherein the transmitting of the ID information of the medical image providing apparatus comprises:
receiving ID information of the user terminal from the user terminal via the NFC;
checking information about permissions assigned to the user terminal, based on the ID information of the user terminal; and
selectively transmitting the ID information of the medical image providing apparatus to the user terminal, based on the information about the permissions.

8. The method of claim 6, further comprising transmitting the medical image to the user terminal via the NFC.

9. A method of providing a medical image, performed by a user terminal, the method comprising:
receiving identification (ID) information of a medical image providing apparatus from the medical image providing apparatus via near-field communication (NFC);
displaying a set of virtual keys mapped to the ID information of the medical image providing apparatus;
receiving a control command from the outside via the set of virtual keys; and
transmitting the control command to the medical image providing apparatus via the NFC.

10. The method of claim 9, further comprising:
receiving a medical image from the medical image providing apparatus via the NFC; and
displaying the medical image.

11. The method of claim 9, further comprising transmitting the medical image to a server.

12. An apparatus for providing medical images, the apparatus comprising:
a communication unit for receiving patient identification (ID) information from a patient terminal via near-field communication (NFC);
a search unit for searching for information about an object to be diagnosed, based on the patient ID information;
an image obtaining unit for obtaining a medical image about the object, based on the searched for information; and
a controller for controlling the communication unit, the search unit, and the image obtaining unit.

13. The apparatus of claim 12, wherein the communication unit transmits ID information of the medical image providing apparatus to a user terminal and receives a control command from the user terminal, via the NFC, and the controller performs the control command.

14. A user terminal comprising:
a communication unit for receiving identification (ID) information of a medical image providing apparatus from the medical image providing apparatus and transmitting a control command received from the outside to the medical image providing apparatus, via near-field communication (NFC);
a display unit for displaying a set of virtual keys mapped to the ID information of the medical image providing apparatus, and receiving the control command from the outside via the set of virtual keys; and
a controller for controlling the communication unit and the display unit.

15. A computer readable recording medium having recorded thereon a computer program for executing the method of claim 1.
